(19) United States
(12) Patent Application Publication
(10) Pub. No.: US 2021/0239041 A1
(43) Pub. Date: Aug. 5, 2021

(54) APPARATUS, PROCESS AND THERMODYNAMIC CYCLE FOR POWER GENERATION WITH HEAT RECOVERY

(71) Applicant: SPADA SRL, Milano (IT)

(72) Inventor: Claudio SPADACINI, Verbania (VB) (IT)

(73) Assignee: SPADA SRL, Milano (IT)

(21) Appl. No.: 17/052,650

(22) PCT Filed: May 2, 2019
(86) PCT No.: PCT/IB2019/053575

§ 371 Date: Nov. 3, 2020

(30) Foreign Application Priority Data
May 4, 2018 (IT) 102018000005073

(51) Int. Cl. F02C 1/10; F02C 6/18; F02C 1/06; F02C 5/06

(52) U.S. Cl. CPC F02C 1/105; F02C 5/06; F02C 1/06; F02C 6/18

(57) ABSTRACT

The present disclosure relates to an apparatus/process/cycle for production of power with heat recovery. The apparatus includes a primary engine and a secondary engine connected downstream of the primary engine to exploit waste heat from the primary engine. The primary engine is an internal combustion engine having an exhaust for exhaust fumes. The secondary engine is a closed-cycle gas turbine comprising a secondary compression device, a secondary gas turbo-expander, a closed circuit crossed by a working fluid and connecting the above-mentioned secondary compression device and the secondary gas turbo-expander. A heat exchanger is arranged downstream of the exhaust and comprises a heat exchange portion of the closed circuit. The heat exchanger is crossed by the exhaust fumes to transfer heat from the exhaust fumes to the working fluid of the closed circuit. The secondary engine also comprises a recuperator operatively disposed in the closed circuit.

### FIELD OF THE INVENTION

The present invention relates to an apparatus, a process and a thermodynamic cycle for the production of power with heat recovery.

The present invention is part of the production of power from heat recovery (Waste Heat Recovery—WHR) from exhaust fumes of internal combustion engines, in particular from gas turbines but also, for example, from otto/diesel internal combustion engines.

The present invention falls within the production of mechanical and/or electrical power downstream of fixed gas turbines, for example for driving operating machines (pumps, compressors, etc.) and/or for electric power production for extended and/or isolated networks, with power from hundreds of kW up to tens and hundreds of MW.

The present invention also falls within the production of mechanical and/or electrical power downstream of mobile gas turbines, for example on board ships or movable on trailers, with powers from a minimum of a few hundred kW up to tens of MW.

### BACKGROUND OF THE INVENTION

The prior art and the market standard for Waste Heat Recovery applications from gas turbines, engines and other recoveries in general, as well as in combined cycles, today consists of Rankine water vapor cycles, available and applied in different variants and different sizes.

Also for Waste Heat Recovery applications, both fixed and mobile, the Rankine Organic Cycles (ORC) are also known and commercially available, which, although offering in some cases efficiencies a little lower than the water vapor cycle, have become successful due to the greater constructive simplicity, the more contained costs, the lacked demand of water and the low demand of operating personnel.

Also known are closed gas cycles, i.e. Brayton closed cycles, also called closed cycle gas turbine (CCGT). These CCGT cycles have been in use for several years between the 1930s and the 1970s for applications for producing power from coal and/or other ‘dirty’ fuels, with a few dozen units constructed.

The public document US 2005/0056001A1 (Frutschi, Dittmann) illustrates a power generation plant for high power applications, such as for example power plants, in which a secondary machine is connected downstream of an open cycle gas turbine and is configured to exploit the residual heat of the exhaust fumes of such a gas turbine. The secondary machine is a closed cycle gas turbine (CCGT) and works with a gaseous process fluid. The closed cycle gas turbine comprises a compressor with intercoolers, a device for heating the process fluid which uses the waste heat of the aforesaid exhaust fumes, a turbine and a heat sink.

The document US 2012/039701 is also known, which illustrates a CO₂ Brayton closed cycle which receives heat, in an exchanger, from exhaust gas at about 1250° C. coming from a combustion chamber.

The document U.S. Pat. No. 3,791,137 is also known, which illustrates a closed cycle gas turbine engine which receives heat from a fluid bed fed with a fuel and with compressed air coming from a compressor of an open cycle gas turbine engine.

### SUMMARY

The Applicant has observed that the Rankine water vapor cycles use boilers of various types and are characterized by good conversion efficiencies but are otherwise complex, require water and relative treatment systems, are relatively slow in load changes and have not particularly good partial load performance. Furthermore, Rankine water vapor cycles can exhibit problems of freezing in cold areas and normally require the presence of professional operators. Their complexity, linked in particular to the conformation of the boiler, of the expander and of the auxiliary systems, among which in particular the water treatment systems for the particular purity required for demineralized water for reintegration and for steam, makes them rather expensive and bulky.

The Applicant has further observed that Organic Rankine (ORC) cycles are less efficient than Rankine water vapor cycles, they must use an intermediate fluid, typically diathermic oil, for reasons of thermal stability and the organic fluids they use are often flammable. Consequently also these systems are bulky and not transportable except for very small sizes.

Due to this shortcoming/limitations, many gas turbine and motor applications are still in an open cycle and have no downstream recovery system installed.

The Applicant has also observed that the closed cycles of gas turbines (CCGT) such as that of US 2005/0056001A1 are designed to recover all the useful heat contained in the exhaust fumes of the gas turbines. For this purpose, US 2005/0056001A1 describes the regulation of the exhaust temperature of the gas turbine (open cycle) in the atmosphere, by adjusting the intake temperature of the last compression stage (of the gas turbine compressor in closed cycle). Having to recover all the heat in order to try to convert it into useful energy, the CCGT cycles of US 2005/0056001A1, which use air as the working fluid, have very high compression ratios, typically ten or more, with the consequence that the temperature discharge rate of the closed cycle expander is approximately equal to the compressor discharge temperature. The exhaust temperature of the expander is similar to the compressor delivery temperature and therefore, assuming also the real compressor and expander yields, it follows that in those areas the compression work is even higher than the expansion work and this limits the performances and cycle efficiency. To overcome this limitation, US 2005/0056001A1 also proposes a CCGT cycle combined with water injection and internal steam production and therefore expansion of a gas and steam mixture.

This arrangement allows the compression ratio to be lowered, however, to the detriment of the simplicity and the size (and therefore the transportability) of the turbomachinery and of the plant as a whole, as well as introducing all the problems related to water treatment and the corrosiveness it creates in the presence of oxygen.

The Applicant has also observed that the known systems such as those described in US 2012/039701 and U.S. Pat. No. 3,791,137 are not actually systems for recovering heat from exhaust gases from internal combustion engines (which could function on their own and whose exhaust heat would be destined to be lost), but more complex systems in which the respective heat sources are engines that would have no reason to exist on their own and if not coupled with a closed Brayton cycle.

In this context, the Applicant has perceived the need to devise an apparatus/process/cycle for the production of power (mechanical and/or electrical energy) with heat recovery (WHR) from internal combustion engines, in particular from gas turbines, which is an improvement over the apparatus/processes/cycles of the prior art, including those described above.

The Applicant has set itself in particular the following objectives:
devising an apparatus/process/cycle for the production of power from WHR with high conversion efficiencies, i.e. equal to or greater than those in use and in particular than those of Rankine vapor cycles;
devising an apparatus/process/cycle for the production of power from WHR which offers, downstream of gas turbines, yields at partial loads even higher than the yield at nominal load;
devising an apparatus/process/cycle for the production of power from WHR capable of working/operating both in electric setup only, partially cogenerative or completely cogenerative, always with optimized turbomachinery yields, thus allowing a flexibility of operation higher than the known cogeneration/CHP (Combine Heat and Power) systems, in the event of any variable thermal loads both seasonally and on a daily or random basis;
devising an apparatus/process/cycle for the production of power from simple and low cost WHR;
devising a compact and easily transportable apparatus/process/cycle for the production of power from WHR and also easy to install and connect;
devising an apparatus/process/cycle for the production of power from WHR which implement the above with modular and scalable parts and components at different power levels, in order to allow producing equal components even for differently sized plants, with consequent cost-effectiveness on a positive scale on construction costs;
devising an apparatus/process/cycle for the production of power from WHR which with a finite number of components, i.e. turbines, compressors, exchangers, covers a whole continuous range of application powers.

The Applicant has found that the aforementioned objectives and others can be achieved by means of a CCGT (Closed Cycle Gas Turbine) of the recuperative type, placed downstream of an internal combustion engine and configured to exploit the heat of the exhaust fumes, preferably up to a temperature above about 180-200° C.

In particular, the indicated and other objectives are substantially achieved by an apparatus, a process and a thermodynamic cycle for the production of power with heat recovery of the type claimed in the appended claims and/or described in the following aspects.

In an independent aspect, the present invention relates to an apparatus for producing power with heat recovery, comprising:

a primary engine and a secondary engine connected downstream of the primary engine to exploit waste heat from said primary engine;
the primary engine being an internal combustion engine having an exhaust for exhaust fumes;
the secondary engine being a closed-cycle gas turbine comprising a secondary compression device, a secondary gas turbo-expander, a closed circuit crossed by a working fluid and connecting said secondary compression device and said secondary gas turbo-expander;

a heat exchanger disposed downstream of the exhaust and comprising a heat exchange portion of the closed circuit, wherein said heat exchanger is crossed by the exhaust fumes to transfer heat from said exhaust fumes to the working fluid of the closed circuit.

In one aspect, the heat exchange portion is directly connected to the secondary gas turbo-expander. Preferably, there are no other heat exchange devices between the heat exchange portion and the secondary gas turbo-expander. Preferably, the heat source for the secondary engine is given only by the exhaust fumes of the primary engine.

In one aspect, an exhaust temperature of the exhaust fumes immediately upstream of the heat exchange portion is comprised between 400° C. and 700° C.

In one aspect, a ratio between a power generated by the primary engine and a power generated by the secondary engine is between one and four, more preferably between two and three.

In one aspect, the closed-cycle gas turbine works according to a subcritical cycle. In this way, the working fluid has a behavior similar to that of an ideal gas.

In one aspect, “Pc” being the critical pressure and “Tc” the critical temperature for a given working fluid and “Pmax” the maximum cycle pressure and “Tmin” the minimum cycle temperature, the working fluid in the closed-cycle gas turbine works with at least one of the following two conditions:

P max<0.9×Pc; and/or

T min>1.2×Tc.

In one aspect, the secondary engine comprises a recuperator operatively disposed in the closed circuit downstream of the secondary gas turbo-expander and upstream the heat exchanger and configured to transfer heat from the working fluid coming out of the secondary gas turbo-expander to the working fluid coming from the secondary compression device and directed to the heat exchanger.

In one aspect, the primary engine is an open-cycle gas turbine and comprises a primary compressor, a primary gas turbo-expander and a combustion chamber operably interposed between the primary compressor and the primary gas turbo-expander. The exhaust fume discharge temperature between 400° C. and 700° C. is the typical temperature of an open cycle gas turbine.

In one aspect, a primary generator is operatively connected to the primary internal combustion engine.

In one aspect, a secondary generator is operatively connected to the secondary gas turbo-expander.

In an independent aspect, the present invention relates to a process for producing power with heat recovery, preferably carried out with the apparatus according to at least one of the listed aspects and/or at least one of the appended claims.

In one aspect, the process comprises: coupling to an exhaust of an internal combustion engine a heat exchange portion of a closed circuit of a closed-cycle gas turbine to transfer heat from exhaust fumes coming from the internal combustion engine to a closed circuit working fluid and heating said working fluid; circulating the working fluid in the closed circuit.

In one aspect, circulating comprises:
entering the working fluid heated by the exhaust fumes into a secondary gas turbo-expander located immediately downstream of said heat exchange portion of the closed circuit and expanding the working fluid in the secondary gas turbo-expander;
entering the expanded working fluid from the secondary gas turbine-expander into a secondary compression device and compress said working fluid and then pass it back into said heat exchange portion.

In one aspect, in a recuperator operatively disposed in the closed circuit downstream of the secondary gas turbo-expander and upstream of said heat exchange portion, the working fluid exiting the secondary gas turbo-expander transfers heat to the working fluid coming from the secondary compression device and directed to said heat exchange portion.

In one aspect, an exhaust temperature of the exhaust fumes immediately upstream of the heat exchange portion is comprised between 400° C. and 700° C. In one aspect, the internal combustion engine is an open cycle gas turbine.

In one aspect, a ratio between a power generated by the open-cycle gas turbine and a power generated by the closed-cycle gas turbine is between one and four, more preferably between two and three.

In one aspect, the working fluid in the closed-cycle gas turbine works in a subcritical state.

In an independent aspect, the present invention relates to a thermodynamic cycle, preferably carried out by the apparatus and/or in the process according to at least one of the listed aspects and/or at least one of the appended claims.

In one aspect, the thermodynamic cycle comprises:
a primary open internal combustion engine cycle;
a secondary closed gas turbine cycle operatively coupled to the primary open cycle to receive a portion of the heat discharged from exhaust fumes of said primary open cycle;
wherein the secondary closed cycle is of the recovery type.

In one aspect, the primary open cycle is a gas turbine cycle.

In one aspect, a discharge temperature of the exhaust fumes is comprised between 400° C. and 700° C.

In one aspect, the secondary closed gas turbine cycle receives heat only from said exhaust fumes.

In one aspect, the secondary closed gas turbine cycle is subcritical.

The Applicant has verified that for applications with heat recovery (WHR), in particular but not exclusively from gas turbines, the closed gas turbine cycle (CCGT) of the recovery type according to the invention, although not using all the sensible heat contained in the exhaust fumes of internal combustion engines, allows obtaining recovery efficiencies equal to and higher than the known Rankine water vapor cycles and higher than the organic cycles (ORC).

The closed gas turbine cycle (CCGT) of the recovery type according to the invention allows maximizing the generated mechanical/electrical power while minimizing the heat recovered and therefore the heat to be disposed of/dissipated in the atmosphere.

Above all, it should be pointed out that the closed gas turbine cycle (CCGT) of the recovery type according to the invention allows a better exergetic performance. In fact, in addition to having a good conversion efficiency, higher or closer to steam and higher than the ORC, it still releases waste heat at a relatively high temperature which therefore has a high exergetic content and allows further recoveries and/or other uses.

Moreover, the Applicant has verified that the closed gas turbine cycle (CCGT) of the recovery type according to the invention can be implemented by means of a very simple and modular system. This system does not use water (and the relative and necessary treatment systems) but uses non-toxic and non-flammable fluids that can exchange heat directly with the gas turbine exhaust fumes.

The Applicant has verified that, due to the presence of the recuperator and to the consequent lower optimized compression ratio, the specific work is lower and the flow rate is greater and it is therefore possible to use turbochargers and expanders also for industrial and aero-derived gas turbines, with advantages in terms of use, maintenance and compactness, and possible transportability. In fact, higher flow rates and lower compression ratios are better suited to the turbomachines that characterize the solution proposed by the Applicant for WHR from industrial and aero-derived gas turbines.

The above is true using air as a working fluid, and therefore also with nitrogen, or nitrogen mixture with a small percentage of oxygen to favor the protection/oxidation of materials at high temperatures, but it is even more true with a monoatomic working fluid such as Argon.

In one aspect, the working fluid is monatomic.

In one aspect, the working fluid is diatomic.

In one aspect, the working fluid is linear triatomic.

In one aspect, the working fluid is selected from the group comprising: Air, Argon, Nitrogen, mixture of Air and Argon, mixture of Argon and Nitrogen, mixture of Air and Nitrogen, Carbon Dioxide. Preferably, carbon dioxide is in subcritical conditions.

Monoatomic fluids, such as the Argon, are characterized by high temperature jumps even with very limited expansion ratios. Argon also, being relatively heavy (about 40 atomic weight), entails contained enthalpy jumps of the turbomachinery. Consequently the turbomachines of a CCGT cycle for WHR from gas turbine to Argon (or also air-Argon or Argon-Nitrogen mixture, etc.) are characterized by low expansion ratios and contained enthalpy jumps. This, together with the fact that the volumetric flow rate can be regulated within certain limits by acting on the minimum/average pressure of the cycle, involves an optimal design and therefore very high efficiency of the turbomachines.

Furthermore, the cited gases are inert, non-flammable and stable as well as being available in the atmosphere and therefore inexpensive.

In one aspect, the power recovery apparatus with heat recovery includes the working fluid.

In one aspect, the secondary closed cycle has an inter-refrigerated compression with at least one inter-refrigeration level.

In one aspect, it is provided to perform at least one inter-refrigeration, preferably at least two inter-refrigerations, during the compression of the working fluid in the secondary compression device.

In one aspect, it is provided to compress the working fluid in the secondary compression device according to a plurality of compression stages and perform an intercooling for each compression stage.

In one aspect, at least one refrigeration device is operatively associated with the secondary compression device and is configured to cool at least part of the working fluid transiting in the secondary compression device.

In one aspect, the secondary compression device comprises a plurality of secondary compressors and a plurality of refrigeration devices operably interposed between the secondary compressors for performing an inter-refrigerated compression.

In one aspect, said part of heat received from the secondary closed cycle is less than 70% of the heat discharged from the open cycle, preferably between 50% and 70% of the heat discharged from the primary open cycle.

In one aspect, the recuperator has an efficiency of at least 80%, preferably greater than 90%.

In one aspect, heat recovery in the closed secondary cycle is greater than 80%, preferably greater than 90%.

In one aspect, an exhaust temperature (upstream of the heat exchange portion) of the exhaust fumes is equal to or greater than 450° C.

In one aspect, an exhaust temperature (upstream of the heat exchange portion) of the exhaust fumes is equal to or less than 650° C.

In one aspect, a temperature of the exhaust fumes immediately upstream of the heat exchange portion is comprised between 170° C. and 300° C., preferably between 185° C. and 250° C., preferably between 190° C. and 220° C.

The Applicant has verified that the use of the recuperator with a minimum efficiency of about 90% (but also up to 80%-85%), together with the use of at least one inter-refrigeration and after selecting the appropriate expansion ratio as a function of the fluid used, provides several advantages and, in particular, it allows reducing the amount of heat recovered from the exhaust fumes (between 50% and 70%), cooling the fumes only up to a temperature of about 170° C.-300° C., thus needing to use very little cumbersome dissipation systems and also much more compact and cost-effective recovery boilers which also create lower pressure losses on the upstream gas turbine, affecting far less performance.

Furthermore, the exhaust fumes, even after the heat exchange with the secondary cycle, retain a significant amount of heat and are available for any other further use. This still available heat may eventually be further used with more suitable technologies at low fume temperatures. For example, the additional heat available (170° C. and 300° C.) can be used for:
further increasing the power by means of an ORC bottoming cycle with respect to the CCGT cycle;
heat cogeneration;
operating a cooling apparatus (chiller), through ORC, or directly with absorption chiller or with gas chiller (gas cycle).

In one aspect, an exhaust temperature of the secondary gas turbo-expander is greater than a delivery temperature of the secondary compression device.

In one aspect, a difference between an exhaust temperature of the secondary gas turbo-expander and a delivery temperature of the secondary compression device is greater than 80° C., preferably greater than 120° C., preferably between 80° C. and 220° C. This difference confers high recovery efficiency of the secondary cycle.

In one aspect, a delivery temperature of said secondary compression device is between 50° C. and 100° C.

In one aspect, a discharge temperature of the secondary gas turbo-expander is between 185° C. and 250° C.

In one aspect, a temperature of the exhaust fumes downstream of the heat exchange portion is substantially the same as the discharge temperature of the secondary gas turbo-expander.

In one aspect, a compression ratio of said secondary compression device is between two and eight.

In one aspect, a compression ratio of said secondary compression device is between three and five if the working fluid is monoatomic. The use of Argon or a mixture with Argon as a working fluid allows the adoption of compression ratios of between three and five and contained enthalpy jumps for the turbomachines, with undoubted advantages in terms of efficiency and also of simplicity and cost.

In one aspect, a compression ratio of said secondary compression device is between six and eight if the working fluid is diatomic.

In one aspect, the recuperator is selected from the group comprising the following types: plate fin coil, primary surface, formed plate, printed circuit.

These recuperator configurations allow obtaining efficiencies of the same recuperator greater than 90% (even 92%-95%) with total pressure losses on the two sides even lower than 5% (even lower than 2%), which allows obtaining high cycle yields.

The closed cycles of gas turbine (CCGT) with heat recovery (WHR) and recuperator according to the invention have low temperature differences and limited thermal transients and therefore the use of the aforementioned types of recuperators is particularly suitable and advantageous in the cycle/apparatus/process according to the invention.

The fact that the cycle/apparatus/process proposed by the Applicant has typical operating temperatures between 50° C. and 290° C. (preferably between 100° C. and 220° C.) allows adopting these types of recuperators and contributes to making this cycle/apparatus/process competitive.

In one aspect, the recuperator is of the finned pack type with continuous fin, preferably made of Cu—Ni. This recuperator is particularly cost-effective and can be used up to about 230° C. Its use is therefore possible in the cycle/apparatus/process according to the invention when the pressures are not excessive, therefore above all for small sizes.

In one aspect, the recuperator is of the finned pack type with continuous fin is made of steel and this allows increasing the operating pressures.

In one aspect, the primary surface recuperator (PSR) or the formed plate recuperator is made using both diffusion bonding and welding techniques.

These recuperator configurations also allow the use of Argon (or Argon and nitrogen or Argon and air mixture, etc.), which is typically a fluid with non-excellent heat exchange performance (as it is heavy and with a modest mass Cp) without penalizing the cycle with significant load losses and allowing very low compression ratios which allow optimization of turbomachinery yields.

In one aspect, it is provided to couple the primary open cycle with an auxiliary organic Rankine cycle (bottoming ORC) configured to receive a part of the residual heat discharged from the primary open cycle after the heat transfer to the secondary closed cycle.

In one aspect, it is provided to couple, to the exhaust of the internal combustion engine and downstream of the heat exchange portion, a circuit of an organic Rankine cycle apparatus (ORC), wherein said organic Rankine cycle apparatus receives heat from the exhaust fumes after said exhaust fumes have transferred heat to the secondary engine.

In one aspect, the apparatus for producing power with heat recovery comprises an Organic Rankine Cycle apparatus (ORC) operably coupled to the exhaust of the primary engine downstream of the heat exchange portion of the closed circuit to receive heat from the exhaust fumes after that the exhaust fumes transferred heat to the secondary engine.

The downstream ORC cycle allows exploiting the significant amount of heat retained by the exhaust fumes after heat exchange with the secondary cycle.

In one aspect, it is provided to couple to the secondary closed cycle an organic Rankine auxiliary cycle (bottoming ORC) configured to receive a part of the heat of the working fluid leaving the secondary gas turbo-expander.

In one aspect, the power recovery apparatus with heat recovery comprises an organic Rankine cycle apparatus (ORC) operatively coupled to the closed secondary cycle to receive heat from the working fluid exiting the secondary gas turbo-expander.

In one aspect, it is provided to couple the primary open cycle with an auxiliary cooling cycle configured to receive a part of the residual heat discharged from the primary open cycle after the heat transfer to the secondary closed cycle, and to cool incoming air in said primary open cycle.

In one aspect, it is provided to couple a cooling apparatus circuit to the exhaust of the internal combustion engine and downstream of the heat exchange portion.

In one aspect, said cooling apparatus receives heat from the exhaust fumes after said exhaust fumes have transferred heat to the secondary engine.

In one aspect, said cooling apparatus cools inlet air to the primary gas turbo-expander.

In one aspect, the apparatus for producing power with heat recovery comprises a cooling apparatus operably coupled to the exhaust of the primary engine downstream of the heat exchange portion of the closed circuit to receive heat from the exhaust fumes after that the exhaust fumes transferred heat to the secondary engine.

In one aspect, the cooling apparatus is operatively coupled to an inlet of the primary compressor to cool incoming air to said primary compressor (inlet cooling).

In one aspect, the cooling apparatus comprises an absorption refrigerator or a first auxiliary motor coupled to a refrigerating unit such as a driven machine or a Brayton cycle refrigerator.

In one aspect, the cooling apparatus comprises a cooling coil arranged at the inlet of the primary compressor.

The cooling apparatus therefore allows producing a refrigerant capable of cooling the air entering the primary gas turbo-expander, obtaining an increase in power and efficiency.

In one aspect, it is provided to couple an auxiliary heating cycle to the secondary closed cycle to withdraw heat from the secondary closed cycle and supply a thermal utility.

In one aspect, a heating circuit is provided to be coupled to the secondary motor, wherein said heating circuit takes heat from the closed circuit and supplies a thermal utility.

In one aspect, the power production apparatus with heat recovery comprises a heating circuit operatively coupled to the secondary motor and which can be coupled to a thermal utility.

The apparatus/process/cycle according to the invention takes a cogeneration configuration (CHP—Combined Heat and Power) and allows producing hot water for district heating (160° C.-180° C.) and/or steam for factories.

In one aspect, the heating circuit comprises at least one auxiliary exchanger operatively coupled to the closed circuit at said secondary compression device.

In one aspect, the heating circuit draws heat between compression stages/compressors of the secondary compression device.

In one aspect, the heating circuit comprises a plurality of auxiliary exchangers interposed between the secondary compressors.

In one aspect, it is provided to adjust the load by injecting working fluid under pressure into the closed circuit or by extracting working fluid from the closed circuit.

In one aspect, the secondary engine comprises a load control device comprising a reservoir for the working fluid under pressure connected to a first point of the closed circuit located upstream of said secondary compression device and to a second point of the closed circuit located downstream of said secondary compression device.

In one aspect, the load control device comprises a compressor or a pump connected to the reservoir to load compressed air into said reservoir or a gas cylinder (preferably a monoatomic working fluid, preferably Argon, or diatomic) operatively connected to said reservoir.

In one aspect, an intake duct, preferably provided with an inlet valve, connects the reservoir for the working fluid under pressure to a point of the closed circuit located upstream of the secondary compression device.

In one aspect, a discharge duct, preferably provided with a discharge valve, connects the reservoir for the working fluid under pressure to a point of the closed circuit located downstream of the secondary compression device.

In one aspect, a load rejection duct, preferably provided with a load rejection valve, connects a point of the closed circuit located downstream of the secondary compression device and before the recuperator and a point of the closed circuit located upstream of the secondary compression device and after the recuperator.

In one aspect, the secondary motor comprises an auxiliary reservoir, preferably having smaller dimensions than the reservoir, connected to a third point of the closed circuit located between the recuperator and the heat exchanger.

In one aspect, an overload (fast overload) duct, preferably provided with an overload valve, connects the auxiliary reservoir to a point of the closed circuit located immediately upstream of the heat exchange portion.

In one aspect, the auxiliary reservoir is connected to the discharge duct.

In one aspect, an auxiliary compressor or auxiliary pump, preferably connected to the discharge duct is connected to the auxiliary reservoir.

In one aspect, the secondary motor comprises a start-up turbine operatively connected to the closed-cycle gas turbine.

In one aspect, a start-up duct, preferably provided with a start-up valve, connects the reservoir to the start-up turbine.

In one aspect, the apparatus for producing power with heat recovery comprises: a first temperature sensor operatively coupled to the closed circuit immediately upstream of the heat exchange portion, to detect a temperature of the working fluid before passing into the heat exchanger.

In one aspect, the apparatus for producing power with heat recovery comprises: a second temperature sensor operatively coupled to the closed circuit immediately downstream of the heat exchange portion, for detecting a temperature of the working fluid after the passage in the heat exchanger.

In one aspect, the apparatus for producing power with heat recovery comprises: a third temperature sensor operatively coupled to the exhaust for exhaust fumes immediately upstream of the heat exchange portion, to detect a temperature of the exhaust fumes before the passage in the heat exchanger.

In one aspect, the apparatus for producing power with heat recovery comprises: a fourth temperature sensor operatively coupled to the exhaust for exhaust fumes immediately downstream of the heat exchange portion, to detect a temperature of the exhaust fumes after the passage in the heat exchanger.

In one aspect, the apparatus for producing power with heat recovery comprises a control unit operatively connected to the first, second, third and fourth temperature sensors, to the intake valve and to the discharge valve, to regulate the load.

In one aspect, the control unit is configured for:
calculating a first difference between the temperature of the exhaust fumes before passing through the heat exchanger and the temperature of the working fluid after passing through the heat exchanger;
calculating a second difference between the temperature of the exhaust fumes after passing through the heat exchanger and the temperature of the working fluid before passing through the heat exchanger;
calculating an error by subtracting the second difference from the first difference;
reducing the load by opening the discharge valve, if the error is greater than zero or increasing the load, by opening the intake valve, if the error is less than zero.

In one aspect, the control unit is operatively connected to the start-up valve and is configured to start the closed-cycle gas turbine by opening said start-up valve.

In one aspect, the control unit is operatively connected to the load rejection valve and is configured to avoid over-speed of the secondary gas turbo-expander by opening said load rejection valve.

In one aspect, the control unit is operatively connected to the overload valve and is configured to overload (fast overload) the secondary gas turbo expander by opening said overload valve.

In one aspect, the closed-cycle gas turbine has a single shaft (single shaft turbomachine). The secondary compression device, preferably provided with a plurality of compression stages (preferably four or five stages, preferably centrifugal), and the secondary gas turbo-expander, preferably provided with a plurality of expansion stages (preferably from two to four axial expansion stages), are mechanically connected by a single shaft.

The Applicant has also found that the apparatus/processes/cycles implemented with the gas turbine with a “single shaft” closed cycle, due to the contained compression/expansion ratios, above all with monoatomic and diatomic fluids, exhibit very high efficiencies, since the “specific speed”, that is, the number of revolutions characteristic of each compression stage, are similar and do not vary much between each stage.

In a different aspect, the closed-cycle gas turbine has a double shaft (double shaft turbomachine) configuration. The closed-cycle gas turbine comprises a first secondary gas turbo-expander and a first secondary compressor mechanically connected by a first shaft. The closed-cycle gas turbine comprises a second secondary gas turbo-expander, a second secondary compressor and a third secondary compressor mechanically connected by a second shaft.

Further features and advantages will become more apparent from the detailed description of preferred but not exclusive embodiments of an apparatus, a process and a thermodynamic cycle according to the present invention.

### DESCRIPTION OF THE DRAWINGS

Such description is given hereinafter with reference to the accompanying drawings, provided only for illustrative and, therefore, non-limiting purposes, in which:

FIG. 1 schematically illustrates an apparatus for producing power with heat recovery according to the invention;

FIG. 2 is a diagram T-S of a closed gas turbine cycle implemented with the apparatus in FIG. 1;

FIG. 3 is a diagram T-Q relating to the apparatus in FIG. 1;

FIG. 4 shows a variant of the apparatus in FIG. 1;

FIG. 9 shows a further variant of the apparatus in FIG. 1;

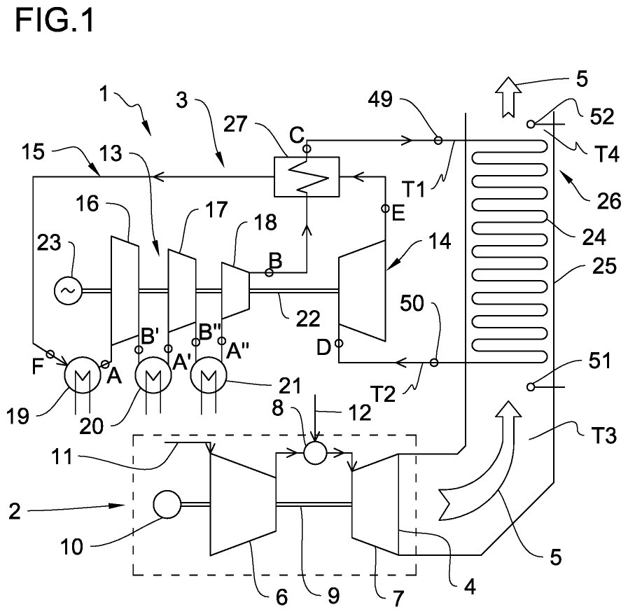

FIG. 5 shows a further variant of the apparatus in FIG. 1;

FIG. 6 shows a further variant of the apparatus in FIG. 1;

FIG. 6A shows diagrams T-S side by side relating to the variant in FIG. 6;

FIG. 7 shows the apparatus in FIG. 1 showing the devices for managing and regulating the same;

FIG. 8 shows a construction variant of a portion of the apparatus in FIG. 1.

### DETAILED DESCRIPTION

With reference to FIG. 1, the reference numeral 1 generally indicates an apparatus for producing power with heat recovery according to the present invention.

The apparatus 1 comprises a primary motor 2 and a secondary motor 3 connected downstream of the primary motor 2 to exploit a part of the waste heat coming from said primary motor 2. The primary motor 2 is able to produce a power from a few hundred kW up to tens of MW depending on the size, and the secondary motor 3 produces a power of the same order of magnitude. In particular, the primary motor 2 produces a power that is from two to three times the power produced by the secondary motor 3.

The primary engine 2 is an internal combustion engine having an exhaust 4 for exhaust fumes 5. In the preferred embodiment shown, the internal combustion engine 2 is an open-cycle gas turbine and comprises a primary compressor 6, a primary gas turbo-expander 7 and a combustion chamber 8 operably interposed between the primary compressor 6 and the primary gas turbo-expander 7. The primary compressor 6 and the primary gas turbo-expander 7 are mechanically connected by a single shaft 9 to which a primary generator 10 is also connected. Air 11 introduced into the primary compressor 6 is compressed and introduced into the combustion chamber 8 in which a fuel 12 is also introduced. Combustion takes place in the combustion chamber 8 and the combusted gases introduced into the primary gas turbo-expander 7 expand, causing the primary gas turbo-expander 7 to rotate and generate mechanical and electrical energy via the primary generator 10. After expansion in the primary gas turbo-expander 7, the exhaust fumes 5 coming out of the exhaust 4 still have usable residual heat.

The secondary engine 3 is a closed-cycle gas turbine CCGT and comprises a secondary compression device 13, a secondary gas turbo-expander 14, a closed circuit 15 crossed by a working fluid and connecting said secondary compression device 13 and said secondary gas turbo-expander 14. In the embodiments shown in FIG. 1, the secondary compression device 13 comprises a first, a second and a third secondary compressor 16, 17, 18 and a first, a second and a third refrigeration device 19, 20, 21. The second and third refrigeration devices 20, 21 are operatively interposed between the secondary compressors 16, 17, 18 along the closed circuit 15, to perform an inter-refrigerated compression. The first refrigeration device 19 is arranged upstream of the first secondary compressor 16. The first, second and third secondary compressors 16, 17, 18 are mechanically connected by a single shaft 22 which also connects the secondary gas turbo-expander 14. A secondary generator 23 is operatively connected to the secondary gas turbo-expander 14 by means of the same single shaft 22, possibly by interposing a gear transmission not shown in the figure. The first refrigeration device 19 is located upstream of the intake of the first compressor 16. The second refrigeration device 20 is interposed between the first compressor 16 and the second compressor 17. The third refrigeration device 21 is interposed between the second and the third compressor 17, 18.

The closed circuit 15 comprises a heat exchange portion 24, shown in FIG. 1 as a coil, located upstream (with respect to a direction of the flow of the working fluid in the closed circuit 15) of the secondary gas turbo-expander 14 and downstream of the compression device 13. The heat exchange portion 24 is operatively coupled to the exhaust 4 of the open cycle gas turbine 2 and defines, with an exhaust channel 25 of said exhaust fumes 5, a heat exchanger 26 crossed by the exhaust fumes 5 of the primary engine 2 and by the working fluid of the secondary motor 3. In this heat exchanger 26, the exhaust fumes 5 transfer heat to the working fluid of the closed circuit 15. The heat exchange portion 24 is directly connected to the secondary gas turbo-expander 14 in the sense that there are no other heat exchange devices between the aforementioned heat exchange portion 24 and the secondary gas turbo-expander 14.

The secondary motor 3 further comprises a recuperator 27 operatively arranged in the closed circuit 15 downstream of the secondary gas turbo-expander 14 and upstream of the heat-exchange portion 24, or of the heat exchanger 26. The recuperator 27 is configured to transfer heat from the working fluid leaving the secondary gas turbo-expander 14 to the working fluid coming from the secondary compression device 13 and directed into the heat-exchange portion 24, or in the heat exchanger 26.

Through the aforementioned recuperator 27 passes a line of the closed circuit 15 which from a discharge of the secondary gas turbo-expander 14 moves towards the compression device 13 entering the first refrigeration device 19. A line of the closed circuit 15 also passes through the aforementioned recuperator 27 which from a delivery of the compression device 13 (in particular from the delivery of the third compressor 18) moves towards the heat exchange portion 24 to subsequently enter an input of the secondary gas turbo-expander 14.

The recuperator 27, which in FIG. 1 is illustrated only schematically, can be of the finned pack, primary surface, formed plate, printed circuit or of the hybrid type, for example with a side of the formed plate type with larger channels for the low-pressure and high-temperature working fluid leaving the secondary gas turbo-expander 14 and a side of the printed circuit type for the high-pressure and low-temperature working fluid leaving the compression device 13.

The working fluid which preferably circulates in the closed circuit 15 of the secondary motor 3 is Argon but in variants of the apparatus/process/cycle of the invention it could be air, Nitrogen, a mixture of air and Argon, a mixture of Argon and Nitrogen, a mixture of air and nitrogen, carbon dioxide.

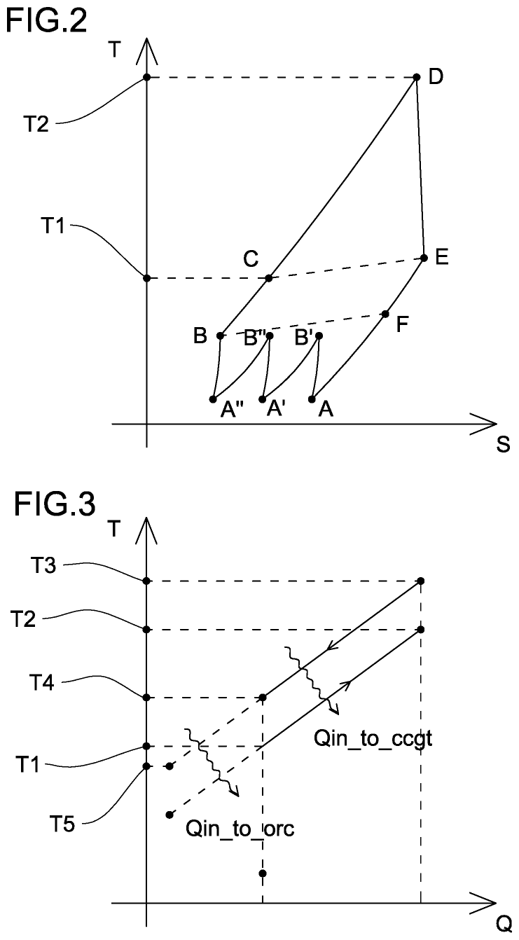

Argon, being a relatively heavy monoatomic fluid (atomic weight of about 40), entails, once the cycle to be implemented has been established, as for example the one represented in FIG. 2, low compression ratios and contained enthalpy jumps of the turbomachinery. Consequently, the turbomachines of the secondary motor 3 of the apparatus 1 according to the invention are characterized by low expansion ratios and contained enthalpy jumps and therefore by a few expansion/compression stages. This implies very high turbomachinery yields.

According to the process for producing power with heat recovery of the present invention implemented through the apparatus 1 described above, the exhaust fumes 5 coming out of the primary gas turbo-expander 7 with a temperature “T₃” for example of about 500° C., pass through the heat exchanger 26 and transfer a part of the heat to the working fluid passing through the heat exchange portion 24.

The working fluid leaving the recuperator 27 runs through the heat exchange portion 24 and is heated from a temperature “T₁” of about 190° C. (point “C” on the diagram in FIG. 2 and on the schematic apparatus in FIG. 1) up to at a temperature “T₂” of about 470° C. (point “D” on the diagram in FIG. 2 and on the schematic apparatus in FIG. 1). The exhaust fumes 5 downstream of the heat exchange portion 24 have a temperature “T₄” of about 210° C.

The working fluid at about 470° C. enters the secondary gas turbo-expander 14, expanding and cooling to a temperature of about 210° C. (point “E” on the diagram in FIG. 2 and on the schematic apparatus in FIG. 1) and producing mechanical power. The temperature “T₄” of the exhaust fumes 5 downstream of the heat exchange portion 24 is therefore substantially equal to a discharge temperature of the secondary gas turbo-expander 14.

The working fluid leaving the secondary gas turbo-expander 14 passes through the recuperator 27 and transfers heat to the working fluid coming from the secondary compression device 13 and directed into the heat exchange portion 24. The working fluid exiting from the secondary gas turbo-expander 14 is further cooled through the recuperator 27 from the temperature of about 210° C. (point “E” on the diagram in FIG. 2 and on the schematic apparatus in FIG. 1) to a temperature of about 90° C. (point “F” on the diagram in FIG. 2 and on the schematic apparatus in FIG. 1).

After having transferred heat into the recuperator 27, the working fluid enters the first refrigeration device 19 which cools it to about 25° C. (point “A” on the diagram in FIG. 2 and on the schematic apparatus in FIG. 1). The working fluid is compressed (and heated) and cooled twice in the first compressor 16, in the second refrigeration device 20, in the second compressor 17, in the third refrigeration device 21 (points B′, A′, B″, A″ on the diagram in FIG. 2 and on the schematic apparatus in FIG. 1) and then compressed in the third compressor 18 to a delivery temperature of about 70° C. (point “B” on the diagram in FIG. 2 and on the schematic apparatus in FIG. 1).

The working fluid leaving the third compressor 18 passes through the recuperator 27 and recovers heat from the working fluid leaving the secondary gas turbo-expander 14, heating up to a temperature of about 190° C. (point “C” on the diagram in FIG. 2 and on the schematic apparatus in FIG. 1) to then re-enter the heat exchange portion 24.

As can be seen, a difference between the discharge temperature of the secondary gas turbo-expander 14 (point “E”, 210° C.) and the delivery temperature of the secondary compression device 13 (point “B”, 70° C.) is about 140° C.

The thermodynamic cycle related to the apparatus and the process according to the invention thus comprises a primary open cycle of an internal combustion engine (in particular of a gas turbine) and a closed secondary cycle of a gas turbine (FIG. 2, points A, B′, A′, B″, A″, B, C, D, E, F) operatively coupled to the primary open cycle to receive a part of the heat discharged from said open primary cycle, wherein the secondary closed cycle comprises an inter-refrigerated compression (F, A, B′, A′, B″, A″, B) and is of the recovery type (B-C, E-F).

The working fluid in the closed cycle gas turbine 3 works in a subcritical state, so as to have a behavior similar to that of an ideal gas. “Pc” being the critical pressure and “Tc” the critical temperature for a given working fluid and “Pmax” the maximum cycle pressure and “Tmin” the minimum cycle temperature, the working fluid in the closed-cycle gas turbine 3 works with at least one of the following two conditions:

P max<0.9×Pc; and/or

T min>1.2×Tc.

The diagram T (temperature)−Q (heat) in FIG. 3 illustrates the heat transfer “Q_{in_to_ccgt}” from the exhaust fumes 5 that cool from the temperature “T₃” to the temperature “T₄” to the working fluid that is heated from the temperature “T₁” to the temperature “T₂”.

The compression ratio of the secondary compression device 13 is between three and five if the working fluid is monoatomic, such as for example Argon. This compression ratio is between six and eight if the working fluid is diatomic, as is the case with air.

The heat recovery carried out by the recuperator 27 in the closed secondary cycle is about 90%, i.e. the recuperator 27 has an efficiency of about 90% or more with total pressure losses on the two sides even lower than 5%.

The part of heat transferred from the primary open cycle and received by the secondary closed cycle is equal to approximately 50%-70% of the heat discharged from said primary open cycle, considering the possible recovery of all the recoverable heat equal to 100% by cooling the fumes 5 up to the delivery temperature of the secondary compressor 3, i.e. the temperature at point B. It should be noted that the portion of heat recovered represents however the part with the highest exergetic content and this allows obtaining high yields and simultaneously a compactness and simplicity of the machinery. In other words, assuming a recovery of 70%, a recovery results and therefore an exergetic exploitation certainly higher than 85-90% of the total. It also follows that the exhaust fumes, even after the heat exchange with the secondary cycle, retain a significant amount of heat and are available for any other further use.

By limiting the minimum temperature of the exhaust fumes to the value T₄, the secondary closed cycle gas turbine (CCGT) is extremely efficient, also due to the contained compression ratio and consequent high yields of the turbomachinery.

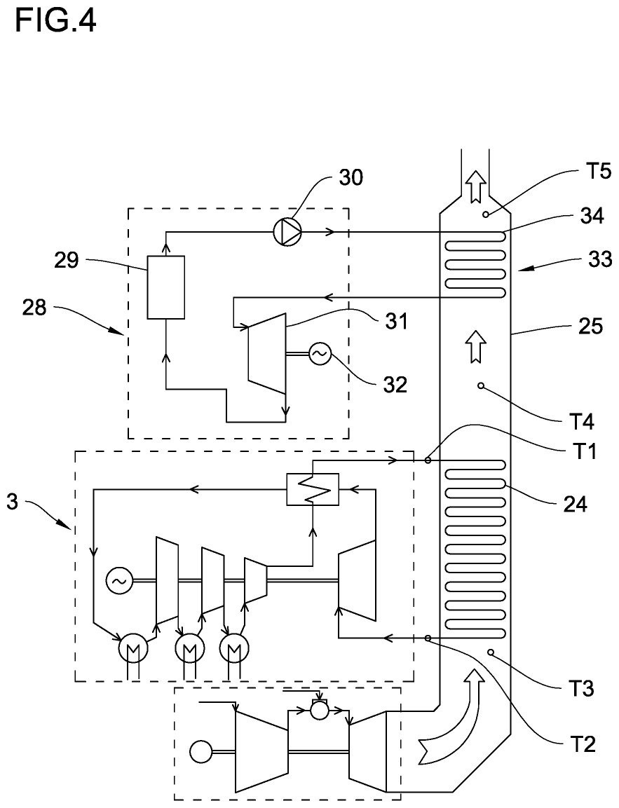

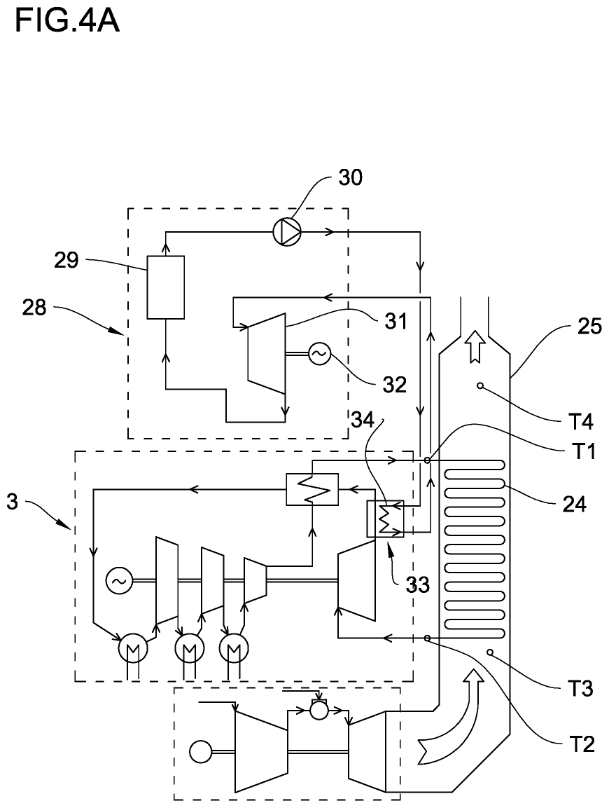

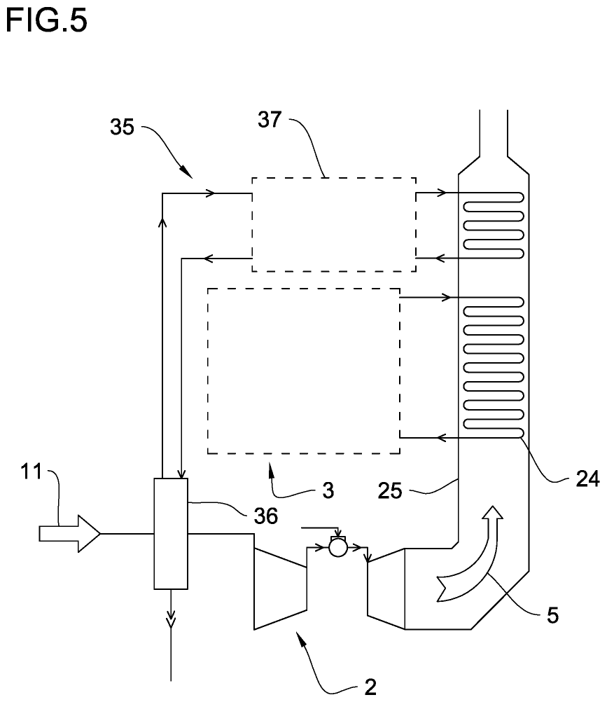

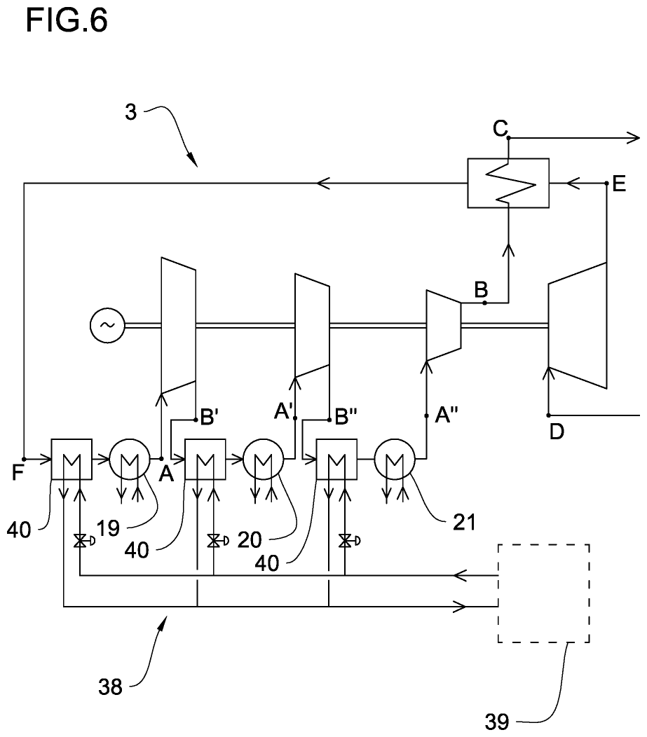

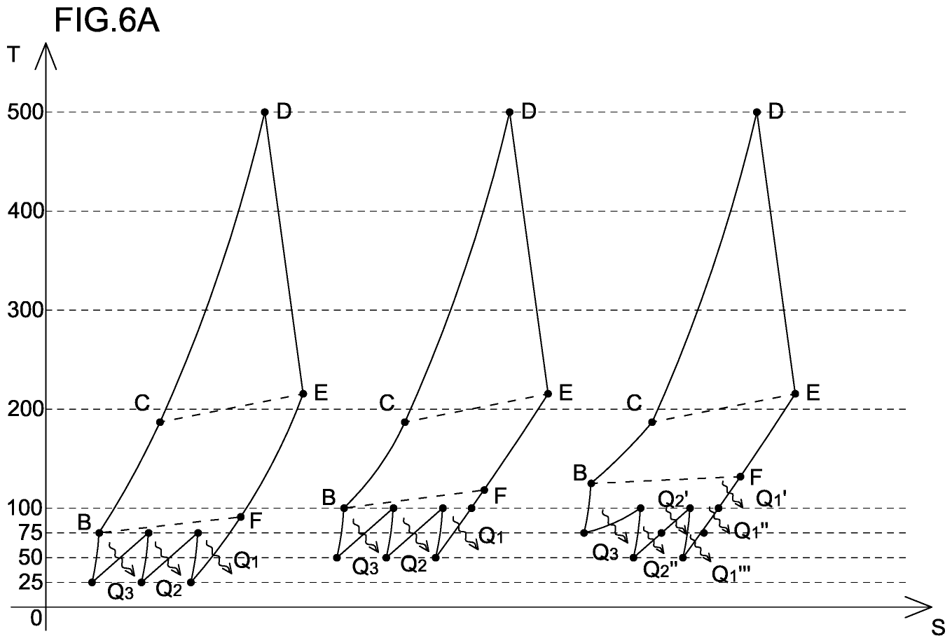

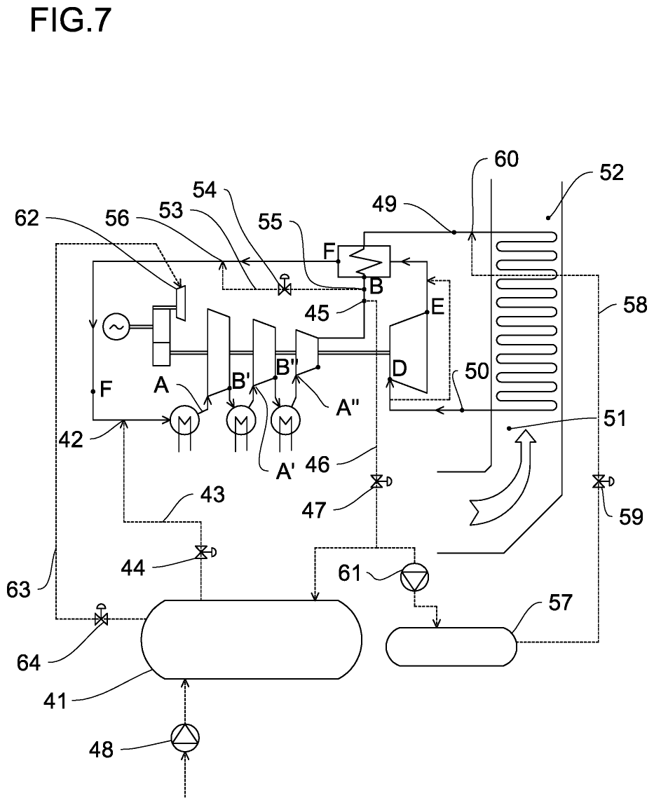

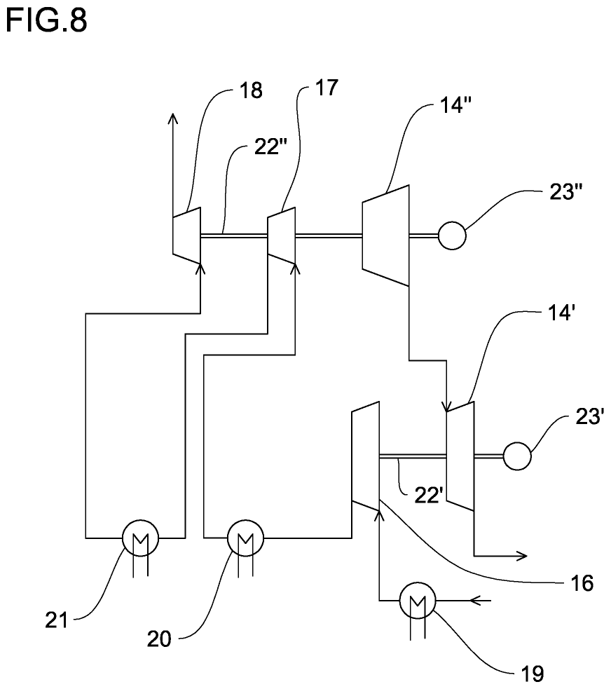

For example, in the embodiment illustrated in FIG. 4, the apparatus 1 further comprises a circuit of an organic Rankine cycle apparatus (ORC) 28, wherein said organic Rankine cycle apparatus 28 receives heat from the exhaust fumes 5 of the primary engine 2 after said exhaust fumes 5 have transferred heat to the secondary engine CCGT 3. The organic Rankine cycle apparatus 28, per se known, comprises a condenser 29, a pump 30, an expander 31 mechanically connected to a respective generator 32 and a heat exchanger/vaporizer 33 defined by a portion 34 of the closed circuit (shown as a coil in FIG. 4) and by a portion of the discharge channel 25 of the open-cycle gas turbine 2 (primary engine). The aforementioned portion 34 of the closed circuit ORC is located downstream of the heat exchange portion 24. In other words, an organic Rankine auxiliary cycle (bottoming ORC) is coupled to the primary open cycle and this organic Rankine auxiliary cycle is configured to receive a part of the residual heat discharged from the primary open cycle, after the transfer of heat to the secondary closed cycle. The downstream ORC cycle allows exploiting the still significant amount of heat retained by the exhaust fumes 5 (T₄=200° C.) after heat exchange with the secondary cycle and therefore increase the overall power of the apparatus 1. As shown in FIG. 3 (dotted line), the exhaust fumes 5 downstream of the portion 34 of the organic Rankine cycle apparatus 28 are cooled to a temperature “T₅” of about 70-120° C., compatibly with the problems of any acidic condensates dependent on the type of fuel 12, typically 70° C. for natural gases and 120° C. for liquid fuels with a moderate sulfur content.

The variant in FIG. 4A is identical to that in FIG. 4 except that the circuit of the organic Rankine cycle apparatus (ORC) 28 receives heat from the working fluid leaving the secondary gas turbo-expander 14 instead of from the exhaust fumes 5. For this purpose, the heat exchanger/vaporizer 33 is defined by the portion 34 of the closed circuit ORC and by a portion of the closed circuit 15 of the secondary motor 3 placed between the secondary gas turbo-expander 14 and the recuperator 27.

In the variant shown in FIG. 5, the apparatus 1 comprises a cooling apparatus 35 (chiller) operatively coupled to the exhaust 4 of the primary engine 2 downstream of the heat exchange portion 24 of the closed circuit 15 to receive heat “Q_{in_to_orc}” from the exhaust fumes 5 after said exhaust fumes 5 have transferred heat to the secondary engine 3 and operatively coupled, for example via a cooling coil 36, to an inlet of the primary compressor 6 to cool inlet air to said primary compressor 6 (inlet cooling). For example, the cooling apparatus 35 comprises an absorption refrigerator or a first auxiliary motor coupled to a refrigerating unit such as a driven machine or a Brayton cycle refrigerator, schematized in FIG. 5 with the element indicated with the reference numeral 37. In other words, it is provided to couple the primary open cycle with an auxiliary cooling cycle configured to receive a part of the residual heat discharged from the primary open cycle after the heat transfer to the secondary closed cycle, and to cool incoming air 11 in said primary open cycle, thus obtaining an increase in power and efficiency.

It is pointed out that this solution is peculiar to the CCGT recovery system object of the present invention. In fact, the Rankine water vapor cycles and also the ORC cycles of the known type and currently in use, in order to obtain optimized efficiencies, must cool the fumes already typically up to 100° C. or even less. This results in an exergetic content of the fumes downstream of said known systems which is very scarce and therefore in fact the impossibility of adopting this solution. Therefore, considering also the increase in efficiency and power of the primary gas turbine 2 (which typically, by cooling the air from 30° C. to 8° C. can also be equal to 15-22% of power and 2-5% of efficiency, respectively), the efficiency of the system according to the present invention can also be much higher than that of the systems in use.

In the embodiment illustrated in FIG. 6, the apparatus 1 assumes a cogeneration configuration (CHP—Combined Heat and Power) and comprises a heating circuit 38 operatively coupled to the secondary motor 3 and which can be coupled to a thermal utility 39 (illustrated only schematically). For example, the thermal utility is a building or a factory and the heating circuit 38 allows producing hot water for district heating (with a temperature of 160° C.-180° C.) and/or steam for factories. In the embodiment illustrated in FIG. 6, the heating circuit 38 comprises a plurality of auxiliary exchangers 40 interposed between the secondary compressors 16, 17, 18 along the closed circuit 15, i.e. each of the auxiliary exchangers 40 is placed in series with a respective refrigeration device 19, 20, 21 and upstream of said refrigeration device 19, 20, 21. The heating circuit 38 therefore draws heat between the compression stages of the secondary compression device 13. In other words, it is provided to couple an auxiliary heating cycle to the secondary closed cycle to withdraw heat from the secondary closed cycle and supply the thermal utility.

FIG. 6A illustrates diagrams T-S side by side relating to the apparatus 1 in FIG. 6. As can be seen, all the thermal loads can be split according to the requirements between the refrigeration devices 19, 20, 21 and between the auxiliary exchangers 40. The available heat can be used or dissipated as required. The diagram T-S in FIG. 6A on the left illustrates the electrical arrangement of the apparatus 1 in which the heat Q1, Q2, Q3 is totally dissipated in the refrigeration devices 19, 20, 21. The diagram T-S in the center shows a mixed arrangement (CHP—Combined Heat and Power) in which the heat Q1, Q2, Q3 is all recoverable, for example between about 100° C. and 50° C., for example for a district heating system. The diagram T-S on the right shows an asymmetric CHP arrangement, in which for example with one of the exchangers 40, a thermal power Q3 is transferred to a utility at a temperature for example of between 100 and 75° C., the powers Q2″ and Q1′ are dissipated in the devices 19 and 20, through two more exchangers 40 the thermal powers Q2′ and Q1′ are transferred between 100 and 75° C., the power Q1′ is transferred between about 100 and 130° C. to a utility at a higher temperature. With this arrangement it is possible to adjust the different quantities of distributable heat at different temperature levels.

It is clear that the apparatus according to the invention allows a cogeneration arrangement to be assumed very efficiently even if this apparatus is not specifically designed for this purpose. The apparatus according to the invention therefore has great operational and even constructive flexibility in terms of standardization.

It should also be noted that, due to the fact that the working fluid behaves like an almost ideal gas, small variations in pressure are sufficient to compensate for any differences in volumetric flow due to variations in temperature at the beginning of compression. It follows that during operation in cogeneration setup, with higher start-up compression temperatures and therefore higher specific volumes, a small increase in minimum cycle pressure (with the same load) is sufficient to compensate for said increase in flow, bringing the turbomachinery back to work near their optimum point. With reference to FIGS. 6 and 6A, with the same flow rate of circulating working fluid, normally the minimum pressure of the cycle (at points E, F) will be slightly higher in the cogeneration case compared to the electric-only case. This adjustment capability, for which the compressors are always brought to work in the central area of their operating map, also entails the possibility of implementing machines for electric setup only and virtually identical cogeneration machines. This translates into high standardization, economy of scale, cost reduction and even technological risk containment, having to make fewer different machines to cover a greater number of different applications.

In other embodiments, not shown, the primary motor 2 and the secondary motor 3 of the CCGT type as described above are combined with one or more of the aforementioned organic Rankine cycle apparatus 28, cooling apparatus 35 and heating circuit 38.

In FIG. 7, the secondary motor 3 is coupled to a load regulation device and to other management devices.

The load adjustment device comprises a reservoir 41 containing the working fluid under pressure. The load adjustment device allows adjusting the load of the secondary motor 3 by introducing a working fluid under pressure in the closed circuit 15 or by extracting the working fluid from the closed circuit 15. The reservoir 41 is connected to a first point 42 of the closed circuit 15 located immediately upstream of the first refrigeration device 19 and therefore upstream of the secondary compression device 13 through an intake duct 43 provided with an intake valve 44. The reservoir 41 is connected to a second point 45 of the closed circuit 15 located immediately downstream of the third secondary compressor 18, through a discharge duct 46 provided with a discharge valve 47. If the working fluid is air, a compressor or a pump 48 is connected to the reservoir 41 to charge compressed air into the reservoir 41 itself. If the working fluid is Argon, a pressurized Argon gas cylinder is operatively connected/connectable to said reservoir 41.

The load adjustment device comprises: a first temperature sensor 49 operatively coupled to the closed circuit 15 immediately upstream of the heat exchange portion 24, to detect the temperature “T₁” of the working fluid before passing into the heat exchanger 26; a second temperature sensor 50 operatively coupled to the closed circuit immediately downstream of the heat exchange portion 24, to detect the temperature “T₂” of the working fluid after passing through the heat exchanger 26; a third temperature sensor 51 operatively coupled to the discharge for exhaust fumes 5 immediately upstream of the heat exchange portion 24, to detect the temperature “T₃” of the exhaust fumes 5 before passing through the heat exchanger 26; a fourth temperature sensor 52 operatively coupled to the exhaust for exhaust fumes immediately downstream of the heat exchange portion 24, to detect the temperature “T₄” of the exhaust fumes 5 after passing through the heat exchanger 26.

A control unit, not shown, is operatively connected to the first 49, to the second 50, to the third 51 and to the fourth 52 temperature sensor, to the intake valve 44 and to the exhaust valve 47. The control unit is preferably of the electronic type and comprises a processing unit (CPU), a memory and interface devices with the elements mentioned above. The control unit is configured to control/manage the load of the secondary motor 3 through the following procedure:
calculating a set point value for the temperature “T₂” of the working fluid after passing through the heat exchanger 26, equal to T₃−DT_{set_point}=set_T₂, where “T₃” is the temperature of the exhaust fumes 5 before passing through the heat exchanger 26 (where “T₃” is measured by the third temperature sensor 51 or supplied by the control unit; wherein DT_{set_point} is the difference in the average terminal temperature);
calculating a first error “Err01” by subtracting the temperature of the working fluid after passing through the exchanger 26, i.e. “T₂” measured by the second temperature sensor 50, at the relative set point, i.e. Err01=T₂−set_T₂;
calculating a first difference “ΔT₁” between the temperature “T₃” of the exhaust fumes 5 before passing through the heat exchanger 26 and the temperature “T₂” of the working fluid after passing through the heat exchanger 26;
calculating a second difference “ΔT₂” between the temperature “T₄” of the exhaust fumes after passing through the heat exchanger and the temperature “T₁” of the working fluid before passing through the heat exchanger 26;
calculating a second error “Err02” by subtracting the second difference “ΔT₂” from the first difference “T₁”;
reducing the load in a predominantly integral and partially proportional manner, opening the discharge valve 47, if the error “Err02” is greater than zero or increasing the load, opening the inlet valve 44, if the error “Err02” is less than zero;
simultaneously reducing the load in a predominantly proportional manner, opening the discharge valve 47, if the error “Err01” is greater than zero or increasing the load, opening the inlet valve 44, if the error “Err01” is less than zero.

As shown in FIG. 7, a load rejection duct 53, provided with a load rejection valve 54, connects a point 55 of the closed circuit 15 located downstream of the secondary compression device 13 and before the recuperator 27 and a point of the closed circuit 56 located upstream of the secondary compression device 13 and after the recuperator 27. The control unit is operatively connected to the load rejection valve 54 and is configured to avoid over-speed of the secondary gas turbo-expander 14 by opening said load rejection valve 54.

The apparatus 1 in FIG. 7 further comprises an auxiliary reservoir 57 smaller than the reservoir 41 and connected, via an overload duct 58 (fast overload), provided with an overload valve 59, to a third point 60 of the closed circuit 15 between the recuperator 27 and the heat exchanger 26. This third point 60 is located immediately upstream of the heat exchange portion 24. The auxiliary reservoir 57 is also connected to the exhaust duct 46 with the interposition of an auxiliary compressor or an auxiliary pump 61. The control unit is operatively connected to the overload valve 59 and is configured to overload the secondary gas turbo-expander 14 by opening said overload valve 59.

The secondary motor shown in FIG. 7 comprises a start-up turbine 62 operatively connected to the closed-cycle gas turbine 3, in particular to gears interposed between the secondary generator 23 and the single shaft 22. A start-up duct 63 provided with a start-up valve 64 connects the reservoir 41 to the start-up turbine 62. The control unit is operatively connected to the start-up valve 63 and is configured to start the closed-cycle gas turbine 3 by opening the start-up valve 64 so as to introduce pressurized air or gas into the start-up turbine 62 which by rotating, transmits the motion to the compression device 13.

The embodiment of the closed-cycle gas turbine 3 in FIG. 8 differs from those illustrated in FIGS. 1, 4, 6 and 7 in that it has a double shaft (double shaft turbomachine) configuration. A first secondary gas turbo-expander 14′ and a first secondary compressor 16 are mechanically connected by a first shaft 22′ connected to a first secondary generator 23′. A second secondary gas turbo-expander 14″, a second secondary compressor 17 and a third secondary compressor 18 are mechanically connected by a second shaft 22″ connected to a second secondary generator 23″. As regards the fluid connection, the first, second and third compressors 16, 17, 18 are arranged in series as in FIGS. 1, 4, 6 and 7. The second secondary gas turbo-expander 14″ is located downstream of the first secondary gas turbo-expander 14′ to receive the already partially expanded working fluid in said first secondary gas turbo-expander 14′.

The present invention, in particular in the embodiments illustrated above, allows obtaining the following advantages:
obtaining an apparatus/process/cycle with high conversion efficiencies, equal to or greater than those in use;
obtaining an apparatus/process/cycle which offers efficiencies at partial loads very close to design efficiencies and therefore much higher than those of the systems in use;
obtaining an apparatus/process/cycle which allows a very rapid start-up time and in any case lower than the technologies in use;
obtaining an apparatus/process/cycle with a competitive cost and with levels of operating pressures that contribute to obtaining such a non-excessive cost;
obtaining an apparatus/process/cycle which does not require the use of water and related treatment devices;
obtaining an apparatus/process/cycle which has no or even positive environmental impact;
obtaining an apparatus/process/cycle which can be implemented with known parts and components already in use or similar to components already in use or in any case with machines of relatively easy and cost-effective implementation;
obtaining an apparatus/process/cycle which is able to start without the aid of external sources (black start);
obtaining an apparatus/process/cycle able to work/operate both in electric setup only, partially cogenerative or completely cogenerative, always with optimized turbomachinery yields;
obtaining a compact and easily transportable apparatus/process/cycle and also easy to install and connect.

1. Heat recovery power plant, comprising:
a primary engine and a secondary engine connected downstream of the primary engine to exploit waste heat from the primary engine;
the primary engine being an internal combustion engine having an exhaust for exhaust fumes;
the secondary engine being a closed-cycle gas turbine comprising a secondary compression device, a secondary gas turbo-expander, and a closed circuit crossed by a working fluid and connecting the secondary compression device and the secondary gas turbo-expander; and
a heat exchanger disposed downstream of the exhaust and comprising a heat exchange portion of the closed circuit, wherein the heat exchange portion is directly connected to the secondary gas turbo-expander, wherein the heat exchanger is crossed by the exhaust fumes to transfer heat from the exhaust fumes to the working fluid of the closed circuit;
wherein the secondary engine comprises a recuperator operatively disposed in the closed circuit downstream of the secondary gas turbo-expander and upstream the heat exchanger and configured to transfer heat from the working fluid coming out of the secondary gas turbo-expander to the working fluid coming from the secondary compression device and directed to the heat exchanger, and
wherein a discharge temperature of the exhaust fumes immediately upstream of the heat exchange portion is comprised between 400° C. and 700° C.

2. Apparatus according to claim 1, wherein a ratio (P1/P2) between a power (P1) generated by the primary engine and a power (P2) generated by the secondary engine is between one and four.

3. Apparatus according to claim 1, wherein the primary engine is an open-cycle gas turbine and comprises a primary compressor, a primary gas turbo-expander and a combustion chamber operably interposed between the primary compressor and the primary gas turbo-expander.

4. Apparatus according to claim 1, wherein the secondary compression device has a compression ratio between two and eight.

5. Apparatus according to claim 1, wherein the secondary compression device comprises a plurality of secondary compressors and a plurality of refrigeration devices operably interposed between the secondary compressors for performing an inter-refrigerated compression.

6. Apparatus according to claim 1, comprising an Organic Rankine Cycle apparatus operably coupled to the exhaust of the primary engine downstream of the heat exchange portion of the closed circuit to receive heat from the exhaust fumes after the exhaust fumes transfer heat to the secondary engine.

7. Apparatus according to claim 1, comprising a cooling apparatus operatively coupled to the exhaust of the primary engine downstream of the heat exchange portion of the closed circuit to receive heat from the exhaust fumes after the exhaust fumes transfer heat to the secondary engine and operatively coupled to an inlet of a primary compressor to cool inlet air to the primary compressor.

8. Apparatus according to claim 5, comprising a heating circuit operably coupled to the secondary engine and connectable to thermal users; wherein the heating circuit comprises a plurality of auxiliary exchangers interposed between the secondary compressors.

9. Apparatus according to claim 1, wherein the secondary engine comprises a load control device comprising a reservoir for the working fluid under pressure connected to a first point of the closed circuit located upstream of the secondary compression device and to a second point of the closed circuit located downstream of the secondary compression device.

10. Process for power generation with heat recovery, the process comprising:
coupling to an exhaust of an internal combustion engine a heat exchange portion of a closed circuit of a closed-cycle gas turbine to transfer heat from exhaust fumes coming from the internal combustion engine to a working fluid in the closed circuit and to heat the working fluid; and
circulating the working fluid in the closed circuit, wherein a discharge temperature of the exhaust fumes immediately upstream of the heat exchange portion is between 400° C. and 700° C.; wherein the circulating comprises:
entering the working fluid heated by the exhaust fumes into a secondary gas turbo-expander located immediately downstream of the heat exchange portion of the closed circuit;
expanding the working fluid in the secondary gas turbo-expander;
entering the expanded working fluid from the secondary gas turbo-expander into a secondary compression device;
compressing the working fluid; and
passing it back into the heat exchange portion;
wherein, in a recuperator operatively disposed in the closed circuit downstream of the secondary gas turbo-expander and upstream of the heat exchange portion, the working fluid exiting the secondary gas turbo-expander transfers heat to the working fluid coming from the secondary compression device and directed to the heat exchange portion.

11. Process according to claim 10, wherein a ratio (P1/P2) between a power (P1) generated by the internal combustion engine and a power (P2) generated by the closed-cycle gas turbine is between one and four.

12. Process according to claim 10, wherein an exhaust temperature of the secondary gas turbo-expander is greater than a delivery temperature of the secondary compression device; and wherein a difference between the exhaust temperature of the secondary gas turbo-expander and the delivery temperature of the secondary compression device is greater than 80° C.

13. Process according to claim 10, wherein a temperature of the exhaust fumes immediately downstream of the heat exchange portion is between 170° C. and 300° C.

14. Process according to claim 10, wherein the working fluid is monoatomic, diatomic, or linear triatomic; and wherein the working fluid is selected from the group consisting of: Air, Argon, Nitrogen, a mixture of Air and Argon, a mixture of Argon and Nitrogen, a mixture of Air and Nitrogen, and Carbon Dioxide.

15. Process according to claim 10, wherein a compression ratio of the secondary compression device is between two and eight.

16. Thermodynamic cycle for power generation and heat recovery, comprising:
a primary open gas turbine cycle; and
a secondary closed gas turbine cycle operatively coupled to the primary open cycle to receive a portion of the heat discharged from exhaust fumes of the primary open cycle;
wherein a discharge temperature of the exhaust fumes is between 400° C. and 700° C., wherein the secondary closed gas turbine cycle receives heat only from the exhaust fumes, and wherein the secondary closed cycle is recuperative.

17. Thermodynamic cycle according to claim 16, wherein the secondary closed gas turbine cycle is subcritical.

18. Thermodynamic cycle according to claim 16, wherein the heat portion received from the secondary closed cycle is between 50% and 70% of the heat discharged from the primary open cycle; and wherein the heat recovery in the secondary closed cycle is greater than 80%.

19. Thermodynamic cycle according to claim 18, wherein the heat recovery in the secondary closed cycle is greater than 90%.

20. Process according to claim 15, wherein the compression ratio is between three and five if the working fluid is monoatomic, and wherein the compression is between six and eight if the working fluid is diatomic.
